(19) United States
(12) Patent Application Publication
(10) Pub. No.: US 2008/0070099 A1
(43) Pub. Date: Mar. 20, 2008

(54) PRIMARY HIGH ENERGY DENSITY BALANCED CELL WITH SAFETY CIRCUIT

(76) Inventor: Joseph Barrella, Yonkers, NY (US)

Correspondence Address: ISRAEL NISSENBAUM, 1038-56TH ST, BROOKLYN, NY, 11219, US

(21) Appl. No.: 11/532,094

(22) Filed: Sep. 14, 2006

(51) Int. Cl. H01M 6/50; H01M 4/40

(52) U.S. Cl. 429/61; 429/231.9; 429/231.95

(57) ABSTRACT

A primary electrochemical cell having a capacity in excess of 0.5 AHr and a high energy density anode comprised of a metal selected from lithium, sodium, potassium, calcium and manganese and a cathode active material, wherein the discharge capacity of the anode is at least substantially equal to or in excess of the discharge capacity of the cathode active material, and wherein said cell further comprises a voltage monitor and cell circuit cut-off whereby when the voltage monitor senses a discharge voltage of about 1.6 or lower, said circuit cut-off are actuated to cut off the cell circuit to thereby prevent hazardous conditions of cell reversal or anode metal plating.

### FIELD OF THE INVENTION

This invention relates to safely increasing capacity of high energy density primary electrochemical cells and batteries and particularly relates to primary cells and batteries having lithium or similar high energy density metal anodes.

### BACKGROUND OF THE INVENTION

It is the normal practice with high energy density cells and batteries such as in lithium and similar metal containing cells and batteries to limit high energy density cell discharge capacity on the basis of anode capacity (i.e., anode limited). This is done in order to prevent the cells containing metals such as lithium from undergoing plating out of the lithium (in a primary non-rechargeable cell) or from going into cell reversal (a common hazard condition in multiple cell batteries) causing safety concerns. These conditions, by the very nature of the high energy density materials contained in the cells, are safety hazards. Cathode materials, however, for the most part are relatively less reactive and/or are not susceptible to similar hazardous conditions.

In effecting such anode limitation, the stoichiometric capacity of the anodes in such cells is deliberately reduced by about 15-25% to that of the cathode capacity and, as a result, in order to ensure safety of such cells, cell overall capacity is reduced by the 15 to 25% stoichiometric reduction of anode capacity. Such methods of abuse resistance with anode capacity limitation are set forth in detail in applicant's U.S. Pat. No. 4,238,554, the disclosure of which is included herein by reference thereto. In cells in which stoichiometric balance is maintained, or in cathode limited cells, the lithium is either intercalated or alloyed whereby reversal and plating is obviated. However, overall cell capacity is, as a matter of course, diminished thereby.

### SUMMARY OF THE INVENTION

It is therefore an object of the present invention to provide lithium or similar high energy density batteries containing cells with a more balanced stoichiometric ratio between anode and cathode capacities with concomitant increases in capacity but without introducing possibility of safety hazards.

It is a further object of the present invention to provide each of the cells with voltage monitoring means to determine the onset of cell reversal coupled with cell shut-off means whereby untoward safety conditions are stopped at their inception.

These and other objects, features and advantages of the present invention will become more evident from the following discussion and drawings in which:

### SHORT DESCRIPTION OF THE DRAWINGS

FIG. 1 is a depiction of a high energy density electrochemical cell with partial cut-out section and with a balanced stoichiometric anode and cathode capacity arranged in series with other cells and with a voltage monitor and cell circuit shutoff member.

### DETAILED DESCRIPTION OF THE INVENTION

Generally the present invention comprises a primary electrochemical cell having a lithium metal anode or similar high energy density anode including sodium, potassium, calcium, magnesium and the like. Typical cathode active materials in such primary cells include sulfur dioxide, thionyl chloride and various metal oxides such as manganese dioxide, cobalt oxide, nickel oxide, iron oxide and the like. In accordance with the present invention the electrodes in the cells are essentially electrochemically balanced to attain maximum capacity from the high energy density electrochemical system. Cells with an overall capacity of at least about 0.5 AHr, can present a safety problem with cell reversal or anode plating in a primary cell. A typical D size cell with a lithium anode, sulfur dioxide depolarizing cathode material and a carbon cathode has capacity of about 8-9 AHr while the slightly more expensive C cell Li/MnO₂ has a capacity of 11-12 AHr with both of such cells being dischargeable at moderate to high discharge rates.

In order to ensure that such anode limited or stoichiometric balanced cells of the present invention are not liable to detrimental cell reversal and the like, the cells are each provided with voltage monitoring means. The voltage monitoring means is electrically placed in the cell discharge circuit and is adapted to trigger cell shut down when the individual cell voltage reaches a dangerous voltage at which untoward conditions will occur. For high energy density cells this is generally about 1.6 volts or lower. The 1.6 volts for the high energy density cells is the point of no return for the reversal/plating condition. The cell shut down means include solenoids which are triggered to mechanically break the cell/battery discharge circuit. Alternatively, solid state power transistors can be used to electrically effect the cut off at the requisite voltage by high resistance. Similar means of cell discharge cutoff are possible and readily available.

In a preferred embodiment the cells are mounted on a flexible circuit board containing the circuitry of a voltage monitor and triggering means for cell/battery-shut off.

### DETAILED DESCRIPTION OF THE DRAWINGS

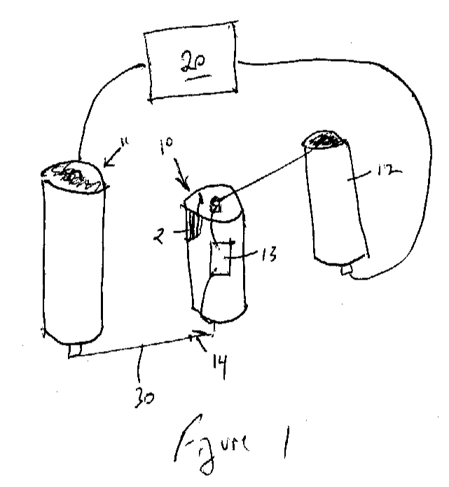

With respect to the drawings, FIG. 1 depicts a typical D size high energy density cell 10 with a lithium anode 1 and a manganese dioxide cathode 2 present in essentially stoichiometric balanced ratio. The cell 10 is shown in linked series circuit 30 with cells 11 and 12 and an electrical device 20 powered thereby. Cell 10 is provided with voltage detector 13 (cells 11 and 12 are similarly provided but not shown). Voltage detector 13 is set with a cutoff voltage monitor of about 1.6 volts. When the cell voltage drops to this level, switch 14 opens and the cell circuit 30 is opened to stop any cell reversal or lithium plating. It is not however sufficient to provide only one cell with the monitor since it may be another cell which undergoes the reversal and voltage drop. The monitor is accordingly preferably attached to all the cells in a battery.

It is understood that the above description and drawings are merely exemplary of the present invention and that changes may be made in cell structure and components as well as the monitoring device and means for cell circuit cut-off without departing from the scope of the present invention as defined in the following claims.

What is claimed is:

1) A primary electrochemical cell having a capacity in excess of 0.5 AHr and a high energy density anode comprised of a metal selected from lithium, sodium, potassium, calcium and manganese and a cathode active material, wherein the discharge capacity of the anode is at least substantially equal to or in excess of the discharge capacity of the cathode active material, and wherein said cell further comprises voltage monitor means and cell circuit cut-off means whereby when the voltage monitor means senses a discharge voltage of about 1.6 or lower, said circuit cut-off means are actuated to cut off the cell circuit to thereby prevent hazardous conditions of cell reversal or anode metal plating.
